(19) United States
(12) Patent Application Publication
(10) Pub. No.: US 2009/0148363 A1
(43) Pub. Date: Jun. 11, 2009

(54) Production of Titanium Tetrachloride Using Fluidized Bed Reactor

(76) Inventors: Machiel Kristen Keegel, Oudorp (NL); Johannes Christiaan Katsman, Hendrik-Ido-Ambacht (NL); Robert Peter Kalmeijer, Rozenburg (NL); Steven Christian Lans, Hoek Van Holland (NL); Pieter Christoffel Van Beek, Hellevoetsluis (NL)

Correspondence Address: HOFFMANN & BARON, LLP, 6900 JERICHO TURNPIKE, SYOSSET, NY, 11791, US

(21) Appl. No.: 11/918,084

(22) PCT Filed: Apr. 25, 2006
(86) PCT No.: PCT/NL2006/000221

§ 371 Date: Nov. 7, 2008

(30) Foreign Application Priority Data
Apr. 26, 2005 (EP) 05075995.0

(51) Int. Cl. C01G 23/02

(52) U.S. Cl. 423/74

(57) ABSTRACT

The invention is directed to a process for the production of TiCl4, in particular to such a process carried out using a fluidized bed process. According to the present invention there is provided a process for the production of TiCl4, which process comprises the steps of: —feeding TiO2 containing ore and coke to a fluidized bed chlorinator; —the assessment of total gas flow entering said chlorinator; —the measurement of the pressure drop inside said fluidized bed for a known height, the pressure drop across said fluidized bed and relating this to the composition of the fluidized bed. —the measurement of the CO:CO2 ratio of the gas flow leaving said fluidized bed chlorinator and relating this to the composition of the fluidized bed—calculating set points for said TiO2 containing ore and coke feed and adjusting said TiO2 and coke feed accordingly.

The invention is directed to a process for the production of TiCl₄, in particular to such a process carried out using a fluidized bed reactor.

Titanium tetrachloride is typically produced by reacting titanium dioxide containing ore with chlorine in the presence of coke at a temperature of approximately 1000° C. in a fluidized bed reactor. The off-gas mainly contains the product TiCl₄ gas, together with CO gas, CO₂ gas and N₂ gas. In the chlorination step ore and coke should be available in large excess with respect to chlorine to ensure a complete reaction of chlorine. Incomplete conversion of chlorine leads to shutdown of the process, which is necessary to avoid venting chlorine to the environment. Incomplete conversion of chlorine also leads to chlorine loss, increased neutralization costs, fouling of downstream coolers, and vanadium contamination in the downstream process.

U.S. Pat. No. 5,670,121 discloses a fluidized bed process for the chlorination of titanium bearing materials wherein COS and CO formation is reduced by controlling the temperature. In this prior art document adjustment of feed ore or coke is not disclosed or suggested, nor is the assessment of gas flows entering the fluidized bed reactor and the measurement of pressure drops.

U.S. Pat. No. 5,538,162 discloses a kind of fluidized bed reactor that is used as a dosing unit. Controlling feed rates is also not disclosed in this prior art document. Pressure drop measurements are apparently carried out to establish the fluidization regime.

The control of the chlorination step is conventionally carried out by monitoring the composition of the chlorinator bed by taking samples at a regular interval (e.g. every two hour) and at the same time by keeping the pressure drop across the fluidized bed reactor constant. Typically, determining the composition involves measuring the density of a sample taken from the fluidized bed using a pycnometer. A complicating factor in this system is the presence of non-reactive silica in the bed, which builds up in time. Based on this information, the ore and coke feed can be adjusted, for instance by varying the open/close times of the blow pots system that is used to feed the reactants to the chlorinator. This system does not allow for an accurately controlled mass flow of ore and coke to the chlorinators. By result, the process has to be shut down regularly to avoid chlorine venting to the atmosphere. In addition, the ore and coke yield is low.

A further complicating factor is the presence of recycle streams in the process, for instance a recycle coming from an oxidation unit.

It is an object of the present invention to provide a chlorination process that is carried out in a fluidized bed reactor, which process does not have the above-mentioned disadvantages and allows automation of this chlorination process.

It was found that this object can be met by a process which combines an online measurement of reactant streams, in particular of the mass flow of ore, coke and total gas flow entering the chlorinator with an online density measurement of the chlorinator fluidized bed.

Thus the present invention relates to a process for the production of TiCl₄ comprising:
feeding TiO₂ containing ore and coke to a fluidized bed chlorinator;
the assessment of gas flows entering said chlorinator;
the measurement of the pressure drop inside said fluidized bed for a known bed height and the pressure drop across said fluidized bed;
the measurement of the CO:CO₂ ratio of the gas flow leaving said chlorinator;
calculating set points for said TiO₂ containing ore and coke feed and adjusting said TiO₂ and coke feed accordingly; and
continuously adjusting said ore an coke feed using a computer control system.

The present inventors found that the composition of the fluidized bed can be calculated conveniently and with a sufficient accuracy from density measured of the bed samples and the measurements of pressure drops across (ΔP_{b}) and inside the bed (ΔPᵢ, which is the pressure drop in the bed for a known bed height).

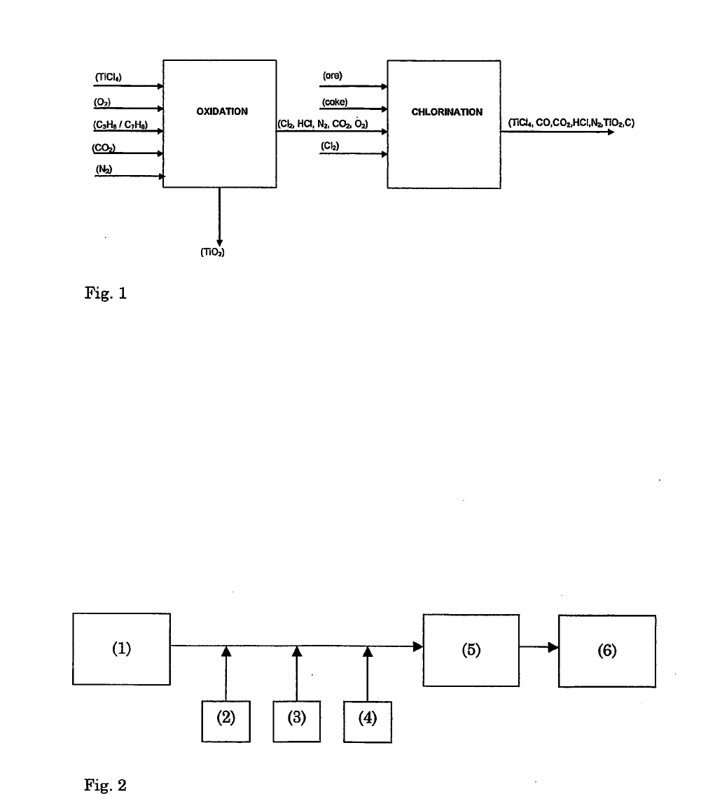

Typically, the production process of TiO₂ comprises an oxidation step and a chlorination step, see FIG. 1. In the oxidation step TiCl₄ is combusted in the presence of an organic fuel (e.g. C₃H₈ and/or C₇H₈, the latter compound commonly being added to increase the flame temperature and to start the reaction between TiCl₄ and O₂) O₂, CO₂, and N₂. The flow of the gasses entering the oxidizer can be accurately measured. From these measurements, the products exiting from the oxidizer can be accurately calculated or measured. These product gasses are used as feed gas for the chlorinator and comprise mainly of Cl₂, HCl, N₂, CO₂, and O₂. Make-up Cl₂ can be added after oxidation. The flow of this make-up Cl₂ addition can also be measured accurately. Besides the feed gas, ore and coke are fed to the chlorinator.

The composition of the chlorinator feed gas can be calculated using the measurements of the gas flows that enter the oxidizer, the N₂ and the make-up Cl₂ added to the system after the oxidizer. The accuracy of this measurement is sufficient to form a basis for an efficient process control.

The Cl₂ in the chlorinator feed gas is a reaction product from oxidation of TiCl₄. Some Cl₂ is consumed by the H₂O that is liberated when the organic fuel reacts with oxygen to form HCl. The flow of Cl₂ entering the chlorinator can be calculated when the flow of O₂ entering the oxidizer is measured, together with the flow of TiCl₄ and the flow of the organic fuel. Make-up Cl₂ can be added to the chlorinators to compensate for Cl₂ losses in the system.

The O₂ in the chlorinator feed gas is the leftover O₂ after oxidation of TiCl₄ to TiO₂ in the oxidizer. To drive this reaction to completion, O₂ is added in excess. Also the combustion of the organic fuel consumes some O₂. The leftover O₂ is fed to the chlorinator. The flow of O₂ entering the chlorinator can be calculated when the flow of O₂ entering the oxidizer is measured, together with the flow of TiCl₄ and the flow of the organic fuel.

The N₂ added to the oxidizer is non-reactive and will all report to the chlorinator feed gas. The CO₂ in the chlorinator feed gas is the reaction product of the combustion of the organic fuel. It is also fed into the oxidizer as carrier gas for the scour sand. Scour sand is added to the oxidizer to prevent buildup of solids in the oxidizer. The flow of CO₂ entering the chlorinator can be calculated when the flow of carrier CO₂ entering the oxidizer is measured, together with the flow of the organic fuel.

The HCl in the chlorinator feed gas is the reaction product of the reaction between Cl₂ and H₂ originating from the organic fuel. The flow of HCl entering the chlorinator can be calculated when the flow of the organic fuel entering the oxidizer is measured.

By measuring the flow of the gasses entering the oxidizer, the flow of make-up Cl₂, and the flow of N₂, the composition of the chlorinator feed gas can be calculated.

Since all inputs to the chlorinator can be either measured or calculated (ore, coke, make-up Cl₂ and composition of the chlorinator recycle gas), also the ore and coke consumption in the chlorinator can be calculated.

The ore entering the chlorinator is either consumed by the reaction with Cl₂ and coke, or leaves the chlorinator unreacted as blowover. The Cl₂ requirement for a ton of ore can be calculated and will not vary significantly. In the normal operating regime of the chlorinator, the unreacted blowover of ore is constant. This allows for an accurate calculation of ore consumption.

Coke entering the chlorinator is consumed by the reaction with O₂ in chlorinator feed gas, and by oxygen present in the TiO₂. Coke also leaves the chlorinator unreacted as blowover. The blowover of coke is assumed constant. The exact consumption of coke is dependent of the CO/CO₂ ratio of the chlorinator off-gas. Continuously measuring the CO/CO₂ ratio of the chlorinator off-gas, allows for an accurate calculation of coke consumption.

As pointed out above, it is a challenge to operate a chlorinator with a tight control over the feed rates of the reactive components ore and coke. The major components of the chlorinator bed are ore, coke, and silica. Where ore and coke are highly reactive, silica is relatively inert and builds up in the chlorinator. However, the inventory of the silica only increases significantly in the order of days.

The chlorinator inventory can be continuously calculated by measuring the overall pressure drop over the fluidized bed (ΔP_{b}) and the internal pressure drop inside the fluidized bed (ΔPᵢ) over a fixed height (h). The bed mass can be calculated from ΔP_{b}, while the bed composition can be calculated from ΔPᵢ.

For the calculation of the bed composition also the mass of silica in the bed and the average density of the bed should be known. The total mass of the silica does not change significantly, and is therefore treated as a semi-constant. The value can be updated daily, based on a chlorinator bed sample that can be analyzed, together with the total bed mass at the time of sampling, to determine the silica content. The average density of the bed can be calculated from the internal pressure drop inside the fluidized bed and the porosity of the fluidized bed. This porosity does not change significantly with variations in operating conditions. The porosity value can be calculated from the density of the fluidized bed, which can be measured with a pycnometer by regularly taking a chlorinator bed sample, for example every two hours.

A tight control over the feed rates of ore and coke is achieved by a combination of an online measurement of reactant streams with online pressure drop measurements, thus allowing a computer control system to continuously set mass flow set points for the ore and coke feed and steer the chlorinator bed inventory to a desired target. As such the operation of the fluidized bed is automated.

The process of the invention allows for continuous operation and makes inter alia complete Cl₂ conversion possible, which in turn may add considerably to the safety of the plant.

In order to compensate for errors in the measurements of the pressure drops and the porosity value of the fluidized bed, several extra control steps may be added.

The instruments that carry out the pressure drop measurements are known to plug with bed solids if not purged regularly. Therefore, double measurements of ΔPᵢ and of ΔP_{b} may be carried out, whereby a deviation between these measurements can be a trigger to purge the measuring instruments.

The determination of the porosity value also introduces a small error. The porosity value is calculated from a regular sampling of the density of the fluidized bed. An average porosity value over at least two density measurements may be used. Preferably, the last three density measurements are used. Thereby the error in the porosity value is dampened over several data points. The average porosity value may be used until a new bed sample is entered, and then recalculated.

Another check may be used by considering the autocorrelation of the samples. Samples that are taken from mixed vessels where the contents have a relatively large residence time compared to the sampling interval are known to be autocorrelated. The residence time of the ore and coke in the chlorinator is in the order of five to ten hours. Therefore, the density values will be autocorrelated if the sampling interval is shorter, for example every two hours.

Two following measurements of the density of the fluidized bed can thus be compared. In practice, when a bed sample has a density that deviates 25% from the previous sample, it is highly likely that the sample is incorrect and should therefore be discarded. Such a deviation could for example trigger the taking of an extra sample from the fluidized bed.

### EXAMPLE 1

The automated control system was built from different segments that are schematically depicted in FIG. 2. The objective was to control the dosing speed of ore and cokes in an existing chlorinator plant, using a controlled set-point. If a selected variable was not equal to the desired value, or was outside of a preset range, a feedback response was given to proportionally adjust the set-point of the ore and coke dosing speed. The dosing speed of ore and cokes was, for example, controlled by the open and closure time of a valve in the dosing line to the chlorinator. The adjustment of the dosing speed is represented by Dosing Program (1) in FIG. 2.

Mass Balance Program (2) was used to calculate the consumptions of ore and coke from the gas flow and composition entering the chlorinator. For instance, when the amount of oxygen in the gas stream entering the chlorinator was increased, the consumption rate of cokes increased as well. A signal corresponding to this change was generated to increase the dosing speed of the cokes feed.

Continuous Bed Inventory Program (3) was used to calculate continuously the coke and ore inventory. When feed rate and consumption rate of reactants were found to be well balanced, the bed composition was found to be constant at a set target. For instance, when the ore inventory rose above target, the bed level increased as well as the bed density and consequently the pressure drop in the bed increased. As a result, the calculated bed inventory increased above target. A signal corresponding to this difference or deviation from target was used to correct the ore dosing speed, as determined by the Dosing Program (1).

CO:CO₂ Measurement (4) was used to measure the ratio of CO and CO₂ gas produced in the chlorinator. The CO:CO₂ ratio is directly related to the cokes inventory in the bed. For instance, when the cokes inventory was above target, the CO:CO₂ ratio was found to increase. A feedback signal to the dosing program was generated to decrease the coke dosing speed to the chlorinator.

The depicted separate segments, or programs run parallel and independent. The generated data is available for the operator, who can use this information for process control in Semi-Automatic mode (5), i.e. manually adjusting the set-point in the Dosing Program (1). When the set-point is adjusted automatically by suitable feedback, the chlorinator is at Fully-Automatic control (6).

The automation package was built in such a way that the complex TiC₄ and TiO₂ production process, involving many measurements, are innovatively used to control that process. Building the program using the segments, the package could be flexibly applied. For instance in the absence of the CO:CO₂ measurement (1), the Mass Balance Program (2) and Continuous Bed Inventory Measurement (3) could be used to control the Dosing Program (1). For instance, in the absence of the Mass Balance Program (2) and Continuous Bed Inventory Measurement (3), the CO:CO₂ measurement (4) could be used solely to control the dosing speed of coke, as well as ore dosing speed.

In the table below the availability of the automated control system in the second half of the year is shown. The availability is the total hours which the automated control system was used as a percentage of the total operating hours in a month. The remainder of the time, the system was controlled by an operator. Obviously, before introduction, the system was continuously controlled manually by an operator

| Month | % |
|---|---|
| July | 93.9 |
| August | 98.8 |
| September | 97.9 |
| October | 96.1 |
| November | 94.3 |
| December | 94.8 |

### EXAMPLE 2

The TiO₂ yield of the improved controls in accordance with the present invention and set out in Example 1 was compared with the TiO₂ yield before installation of the improved controls.

The first three months before implementation of the improved controls, the TiO₂ yield in chlorination was respectively 92.9%, 93.3% and 92.9%. The first three months after implementation of the improved controls, the TiO₂ yield in chlorination was 95.1, 95.0 and 95.0%, respectively. The improvement in TiO₂ yield before and after implementation was 2.0%.

1. Process for the production of TiCU₄, which process comprises the steps of:
feeding TiO₂ containing ore and coke to a fluidized bed chlorinator;
the assessment of gas flows entering said chlorinator;
the measurement of the pressure drop inside said fluidized bed for a known bed height and the pressure drop across said fluidized bed;
the measurement of the CO:CO₂ ratio of the gas flow leaving said chlorinator;
calculating set points for said TiO₂ containing ore and coke feed and adjusting said TiO₂ and coke feed accordingly; and
continuously adjusting said ore and an coke feed using a computer control system.

2. Process according to claim 1, wherein said gas flows entering said chlorinator comprise a recycle stream from an oxidation process.

3. Process according to claim 2, wherein the assessment of gas flows entering said chlorinator comprises the measurement of gas flows entering said oxidation process and the measurement or calculation of the composition of said gas flows.

4. Process according to claim 1 comprising a regular sampling of the fluidized bed to measure the density of the fluidized bed.

5. Process according to claim 1 comprising a regular sampling of the fluidized bed to analyze the silica content of the fluidized bed.

6. Process according to claim 1, wherein a double measure of the pressure drop inside said fluidized bed for a known bed height is performed and the deviation between the measurements is analyzed.

7. Process according to claim 1, wherein a double measure of the pressure drop across said fluidized bed is performed and the deviation between the measurements is analyzed.

8. Process according to claim 4, wherein an average porosity of the fluidized bed is calculated from at least two porosity measurements.

9. Process according claim 4, wherein a second measurement of the density of said fluidized bed at a certain point in time is compared with a first measurement of the density of said bed at an earlier point in time, followed by comparing said first and said second measurement, optionally followed by discarding said second measurement if the difference between said first and said second measurement is too large.

10. Process according to claim 9, wherein said second measurement is discarded if said second measurement is more than 25% larger or smaller than said first measurement.
